(19) United States
(12) Patent Application Publication
(10) Pub. No.: US 2015/0360598 A1
(43) Pub. Date: Dec. 17, 2015

(54) TRUCK BED EXTENDER DEVICE

(71) Applicant: Gerald Lawhon, Alexander, AR (US)

(72) Inventor: Gerald Lawhon, Alexander, AR (US)

(21) Appl. No.: 14/302,089

(22) Filed: Jun. 11, 2014

(51) Int. Cl. B60P 3/40; B60D 1/58; B60D 1/52

(52) U.S. Cl. CPC B60P 3/40; B60D 1/52; B60D 1/58

(57) ABSTRACT

An extended load device may include a boom adapted to attach to a hitch of a vehicle. A support bracket assembly may be adapted to be adjustably attached to the boom. The support bracket assembly may be positioned at a height in line with a height of a vehicle bed and adapted to support items extending beyond the vehicle bed. An auxiliary trailer bracket assembly may be adapted to allow a trailer to attach to the extended load device.

### BACKGROUND OF THE INVENTION

The present invention relates to truck accessories and, more particularly, to an extended load device for a truck that allows items hanging off of truck beds to be supported.

Currently, truck beds can be too small for most consumers to carry what they need. When carrying long items in a truck bed, these items may extend beyond the tailgate or truck bed. These long items may be difficult to support or tie down.

As can be seen, there is a need for a support device that can attach to a trailer hitch of a truck to provide support for a load that extends beyond the truck bed.

### SUMMARY OF THE INVENTION

In one aspect of the present invention, a extended load device comprises: a boom adapted to attach to a hitch of a vehicle; and a support bracket assembly adapted to be adjustably attached to the boom, the support bracket assembly being positioned at a height in line with a height of a vehicle bed and adapted to support items extending beyond the vehicle bed.

In another aspect of the present invention, a method for hauling a long load on a truck comprises: attaching a boom of an extended load device to a hitch of a vehicle, wherein the extended load device is defined by the boom adapted to attach to a hitch of a vehicle, and a support bracket assembly adapted to be adjustably attached to the boom, wherein the support bracket assembly is positioned at a height in line with a height of a vehicle bed and adapted to support items extending beyond the vehicle bed; lowering a vehicle tailgate down; and placing the long load on the vehicle bed and extended load device.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is perspective view/exploded view of an exemplary embodiment of the present invention;

FIG. 3 is a perspective view of an exemplary embodiment of the present invention;

FIG. 4 is a side view of an exemplary embodiment of the present invention; and

FIG. 5 is an exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an extended load device that may include a boom adapted to attach to a hitch of a vehicle. A support bracket assembly may be adapted to be adjustably attached to the boom. The support bracket assembly may be positioned at a height in line with a height of a vehicle bed and adapted to support items extending beyond the vehicle bed. An auxiliary trailer bracket assembly may be adapted to allow a trailer to attach to the extended load device.

The present invention may help carry long loads, such as lumber or other long materials, that would otherwise hang off the end of a truck bed. The truck bed extender device, with an auxiliary trailer bracket, may allow a user to attach a trailer to their vehicle while hauling a long load that may hang off their truck bed.

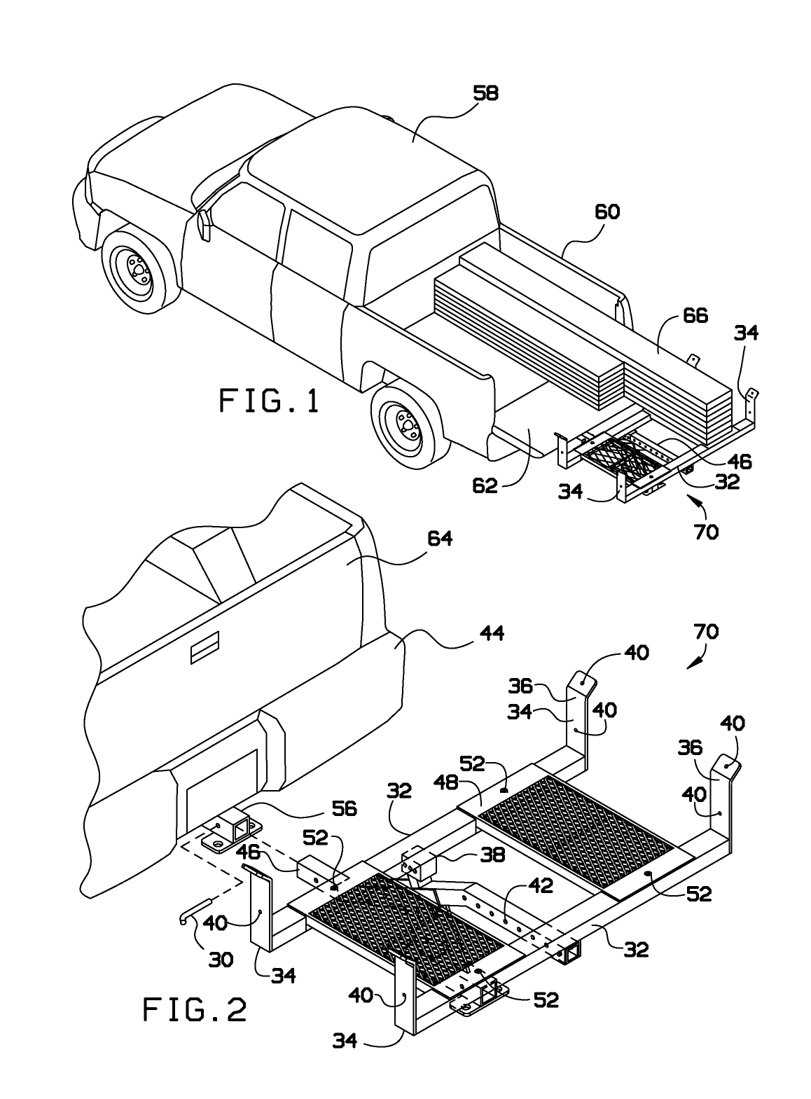

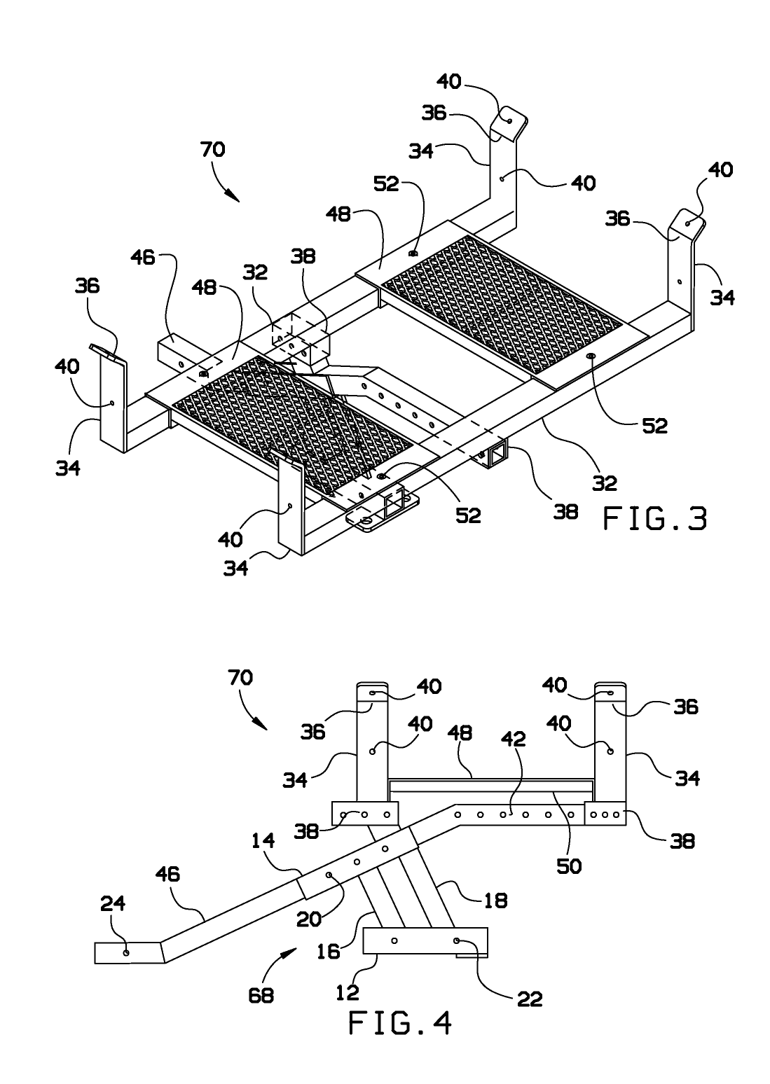

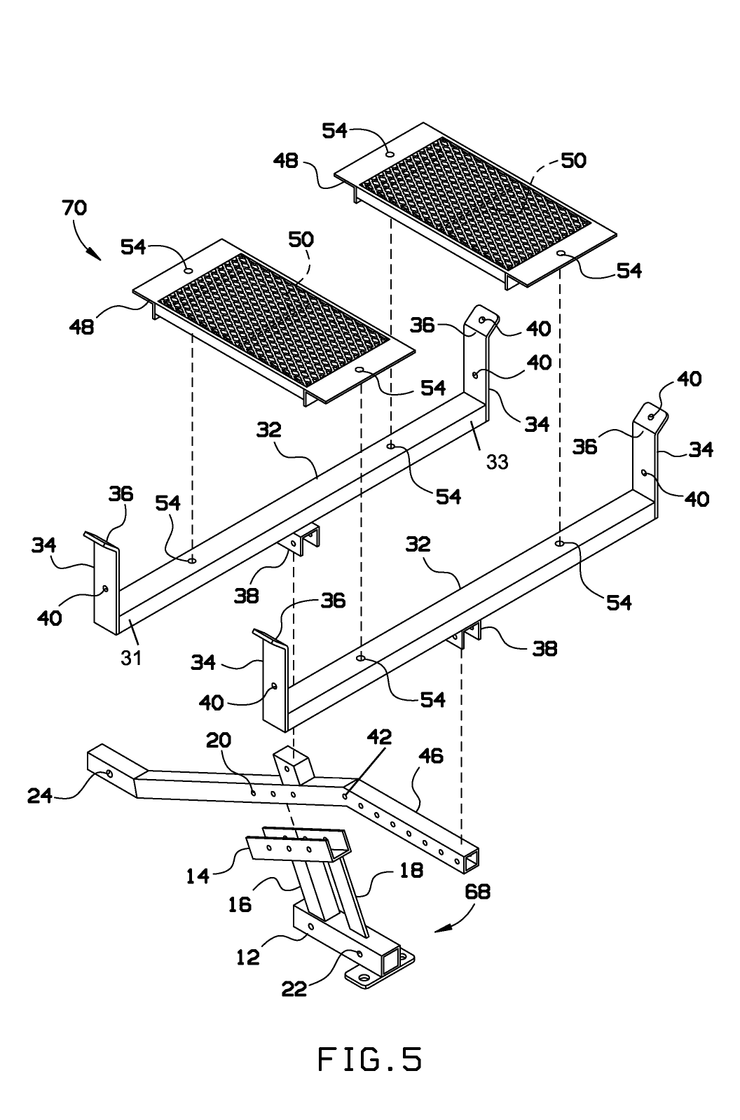

As is illustrated in FIGS. 1 through 5, a truck bed extender device may include a boom 46. The boom 46 may have a plurality of support bracket assembly mounting holes 42 and a plurality of auxiliary trailer bracket mounting holes 20. The support bracket assembly mounting holes 42 may allow for a support bracket assembly 70 to mount to the boom 46. In certain embodiments, the support bracket assembly 70 may adjustably mount to the boom 46 due to the placement of the support bracket assembly mounting holes 42. The boom 46 may connect to a hitch 56 on a vehicle such as a truck 58 or the like.

In certain embodiments, the support bracket assembly 70 may include at least one rectangular piece 32 having a first end 31 and a second end 33. Each rectangular piece 32 may have an approximately perpendicular flat bar 34 attached to the first end 31 and the second end 33. Each flat bar 34 may have a flat bar hole 40. Each flat bar 34 may have a bended section 36, which may have a flat bar hole 40 as well. The rectangular pieces 32 may include expanded platform mounting holes 54. Each rectangular piece 32 may have a rectangular piece mounting channel 38. Each rectangular piece 32 may attach to the boom 46 by attaching the rectangular piece mounting channel 38 to the boom 46 and connecting through one of the support bracket assembly mounting holes 42. At least one expanded platform 48 may be attached to the at least one rectangular piece 32. In certain embodiments, two expanded platforms 48 may attach to two rectangular pieces 32. Each expanded platform 48 may include expanded platform mounting holes 54 and an expanded platform support tread 50. The expanded platforms 48 may be attached to the rectangular pieces 32 by fasteners 52. The expanded platform support tread 50 may allow for traction for components positioned on the device, in order to decrease movement on the device.

In certain embodiments, a removable auxiliary trailer bracket assembly 68 may be attached to the boom 46. The auxiliary trailer bracket assembly 68 may include an auxiliary trailer bracket receiver hitch square tubing 12, an auxiliary trailer bracket mounting channel 14, an auxiliary trailer bracket square tubing 16, an auxiliary trailer bracket square tubing 18, and at least one auxiliary trailer bracket receiver hitch pin hole 22. The auxiliary trailer bracket mounting channel 14 may attach to the plurality of auxiliary trailer bracket mounting holes 20 of the boom 46. The auxiliary trailer bracket mounting channel 14 may attach to the auxiliary trailer bracket square tubing 16 and the auxiliary trailer bracket square tubing 18. The auxiliary trailer bracket square tubing 16 and the auxiliary trailer bracket square tubing 18 may attach to the auxiliary trailer bracket receiver hitch square tubing 12. The auxiliary trailer bracket receiver hitch square tubing 12 may include the at least one auxiliary trailer bracket receiver hitch pin hole 22. The auxiliary trailer bracket assembly 68 may allow for another trailer attachment.

A method of using the truck bed extender device may include the following. The boom 46 may be attached to the hitch 56 of the truck 58. A receiver hitch pin hole 24 on the boom 46 may be exposed along the hitch 56, and a receiver hitch pin 30 may be positioned within the hitch 56 and receiver hitch pin hole 24 to removably secure the device in place. The device may be attached to the truck while a truck tailgate may be in the raised position 64. An extended load 66 may then be placed in a truck bed 60 with a truck tailgate in the lowered position 64 over the truck rear bumper 44.

In certain embodiments, the device may be used to support accessories for activities such as hunting, fishing and the like. Gear may be placed on the device, and a secondary hitch may enable the user to pull an additional vehicle, such as a boat or the like, as well as other objects.

It should be understood, of course, that the foregoing relates to exemplary embodiments of the invention and that modifications may be made without departing from the spirit and scope of the invention as set forth in the following claims.

What is claimed is:

1. An extended load device comprising:
a boom adapted to attach to a hitch of a vehicle; and
a support bracket assembly adapted to be adjustably attached to the boom, wherein the support bracket assembly is positioned at a height in line with a height of a vehicle bed and adapted to support items extending beyond the vehicle bed.

2. The extended load device of claim 1, further comprising a removable auxiliary trailer bracket assembly attached to the boom, the auxiliary trailer bracket assembly adapted to allow a trailer to attach to the extended load device.

3. The extended load device of claim 1, further comprising at least one expanded platform attached to the support bracket assembly.

4. The extended load device of claim 1, wherein the support bracket assembly comprises two rectangular pieces having a first end and a second end, each having a mounting channel to adjustably attach to the boom, wherein each rectangular piece has an approximately perpendicular flat bar on the first end and the second end of the rectangular piece.

5. A method for hauling a long load on a truck comprising:
attaching a boom of an extended load device to a hitch of a vehicle, wherein the extended load device is defined by the boom adapted to attach to a hitch of a vehicle, and a support bracket assembly adapted to be adjustably attached to the boom, wherein the support bracket assembly is positioned at a height in line with a height of a vehicle bed and adapted to support items extending beyond the vehicle bed;
lowering a vehicle tailgate down; and
placing the long load on the vehicle bed and extended load device.

6. The method of claim 5, wherein the extended load device further comprises a removable auxiliary trailer bracket assembly attached to the boom, the auxiliary trailer bracket assembly adapted to allow a trailer to attach to the extended load device.

7. The method of claim 5, wherein the extended load device further comprising at least one expanded platform attached to the support bracket assembly.
